(19) United States
(12) Patent Application Publication
(10) Pub. No.: US 2018/0093404 A1
(43) Pub. Date: Apr. 5, 2018

(54) RETARDATION PLATE AND METHOD FOR PRODUCING RETARDATION PLATE

(71) Applicant: ZEON CORPORATION, Chiyoda-ku, Tokyo (JP)

(72) Inventors: Taku HATANO, Tokyo (JP); Kazuya GOUDA, Tokyo (JP)

(73) Assignee: ZEON CORPORATION, Chiyoda-ku, Tokyo (JP)

(21) Appl. No.: 15/553,672

(22) PCT Filed: Feb. 18, 2016
(86) PCT No.: PCT/JP2016/054759

§ 371 Date: Aug. 25, 2017

(30) Foreign Application Priority Data
Mar. 3, 2015 (JP) 2015-041334

(51) Int. Cl. B29C 47/06; B32B 7/02; B32B 27/30; G02B 5/30; G02F 1/13363

(52) U.S. Cl. CPC B29C 47/06; B32B 7/02; B29C 55/04; G02B 5/3083; G02F 1/13363; B32B 27/30

(57) ABSTRACT

A phase difference plate including: a first layer which is formed from a resin having a positive intrinsic birefringence value, and has birefringence; and a second layer which is formed from a resin having a negative intrinsic birefringence value, and has birefringence, wherein a retardation Re(450) at a wavelength of 450 nm of the phase difference plate, a retardation Re(550) at a wavelength of 550 nm of the phase difference plate, and a thickness d of the phase difference plate satisfy formula (I) Re(450)/Re(550)<0.92 and formula (II) Re(550)/d>0.0035; and production method therefor.

### FIELD

The present invention relates to a phase difference plate and a method for producing a phase difference plate.

### BACKGROUND

A phase difference plate is widely used as a constituent of a display device such as a liquid crystal display device and an organic electroluminescent (hereinafter, sometimes referred to as “organic EL”) display device. Such a phase difference plate is generally required to uniformly exhibit a desired retardation (for example, a ¼ wavelength or a ½ wavelength) in a desired wavelength region (for example, in the entirety of a visible region).

From the viewpoint of expressing a uniform retardation in a desired wavelength region as described above, there has been developed, as a phase difference plate, a phase difference plate having an inverse wavelength dispersion retardation. As described herein, the inverse wavelength dispersion retardation refers to a retardation which exhibits a larger value for a transmitted light having a longer wavelength. That is, in a phase difference plate having an inverse wavelength dispersion retardation, the retardation of transmitted light of a long wavelength exhibits a value which is larger than that of the retardation of transmitted light of a short wavelength. Such a phase difference plate having an inverse wavelength dispersion retardation can exhibit a retardation having a desired value in a wide wavelength band, thereby uniformly expressing its functions in a wide wavelength band. As such a phase difference plate having an inverse wavelength dispersion retardation, there is known a phase difference plate produced by combining a resin having a positive intrinsic birefringence value and a resin having a negative intrinsic birefringence value as described in Patent Literatures 1 to 3.

### CITATION LIST

### Patent Literature

Patent Literature 1: Japanese Patent Application Laid-Open No. 2002-40258 A (corresponding publication: U.S. Patent Application Publication No. 2002/005925)

Patent Literature 2: Japanese Patent Application Laid-Open No. 2001-42121 A

Patent Literature 3: Japanese Patent Application Laid-Open No. 2010-78905 A

### SUMMARY

### Technical Problem

The prior-art phase difference plate having an inverse wavelength dispersion retardation usually obtained an inverse wavelength dispersion retardation as a difference between the retardation expressed in the resin having a positive intrinsic birefringence value and the retardation expressed in the resin having a negative intrinsic birefringence value. Specifically, the phase difference plate was obtained by combining the resins such that, as the wavelength of transmitted light is longer, a difference between the retardation expressed in the resin having a positive intrinsic birefringence value and the resin having a negative intrinsic birefringence value becomes large.

However, it is difficult to reduce the thickness of the aforementioned prior-art phase difference plate having an inverse wavelength dispersion retardation due to the mechanism of utilizing the difference between the retardation expressed in the resin having a positive intrinsic birefringence value and the retardation expressed in the resin having a negative intrinsic birefringence value. Specifically, in the phase difference plate having an inverse wavelength dispersion retardation, the resin from which a retardation is subtracted, of the resin having a positive intrinsic birefringence value and the resin having a negative intrinsic birefringence value, is required to be thickened by the amount of the subtracted retardation. The resin which subtracts a retardation is required to have a specific thickness so that the resin can express an appropriate retardation which allows inverse wavelength dispersion to be expressed in the retardation of the entire phase difference plate. Consequently, it is difficult to reduce the thickness of the phase difference plate having an inverse wavelength dispersion retardation to a degree that is less than a certain limit, compared to another phase difference plate including a single resin.

The present invention has been devised in view of the aforementioned problem. An object of the present invention is to provide a thin phase difference plate having an inverse wavelength dispersion retardation, and a method for producing a thin phase difference plate having an inverse wavelength dispersion retardation.

### Solution to Problem

The present inventor has intensively conducted research for solving the aforementioned problem. As a result, the present inventor has achieved a thin phase difference plate having an inverse wavelength dispersion retardation, by confining retardation and thickness within specific ranges of a phase difference plate including a first layer which is formed from a resin having a positive intrinsic birefringence value and has birefringence, and a second layer which is formed from a resin having a negative intrinsic birefringence value and has birefringence. Thus, the present invention has been completed.

That is, the present invention is as follows.

(1) A phase difference plate comprising:

a first layer which is formed from a resin having a positive intrinsic birefringence value, and has birefringence; and

a second layer which is formed from a resin having a negative intrinsic birefringence value, and has birefringence, wherein

a retardation Re(450) at a wavelength of 450 nm of the phase difference plate, a retardation Re(550) at a wavelength of 550 nm of the phase difference plate, and a thickness d of the phase difference plate satisfy formula (I) and formula (II),

Re(450)/Re(550)<0.92 (I), and

Re(550)/d>0.0035 (II).

(2) The phase difference plate according to (1), wherein at least one of the resin having a positive intrinsic birefringence value and the resin having a negative intrinsic birefringence value is a crystallizable resin.

(3) The phase difference plate according to (2), wherein the resin having a positive intrinsic birefringence value contains a crystallizable cyclic olefin polymer.

(4) The phase difference plate according to (3), wherein the crystallizable cyclic olefin polymer has a syndiotactic structure.

(5) The phase difference plate according to according to any one of (2) to (4), wherein the resin having a negative intrinsic birefringence value contains a crystallizable styrene-based polymer.

(6) The phase difference plate according to (5), wherein the crystallizable styrene-based polymer has a syndiotactic structure.

(7) The phase difference plate according to any one of (1) to (6), wherein
the phase difference plate has a long-length shape,
an angle formed between a slow axis of the first layer and a longitudinal direction of the phase difference plate is 400 or more and 50° or less, and
an angle formed between a slow axis of the second layer and a longitudinal direction of the phase difference plate is −50° or more and −40° or less.

(8) The phase difference plate according to any one of (1) to (7), comprising, between the first layer and the second layer, a third layer which contains an elastomer.

(9) The phase difference plate according to (8), wherein the elastomer is an aromatic vinyl-conjugated diene-based elastomer.

(10) A method for producing a phase difference plate, the method comprising:
a first step of co-extruding a resin having a positive intrinsic birefringence value and a resin having a negative intrinsic birefringence value to obtain a pre-stretch layered body which includes a first layer formed from the resin having a positive intrinsic birefringence value and a second layer formed from the resin having a negative intrinsic birefringence value;
a second step of stretching the pre-stretch layered body after the first step to obtain a stretched body, wherein a retardation Re(450) at a wavelength of 450 nm of the stretched body and a retardation Re(550) at a wavelength of 550 nm of the stretched body satisfy formula (I); and
a third step of promoting crystallization of at least one of the resin having a positive intrinsic birefringence value and the resin having a negative intrinsic birefringence value of the stretched body after the second step to obtain a phase difference plate in which the retardation Re(550) at a wavelength of 550 nm and a thickness d satisfy formula (II),

Re(450)/Re(550)<0.92 (I), and

Re(550)/d>0.0035 (II).

### Advantageous Effects of Invention

According to the present invention, there can be provided a thin phase difference plate having an inverse wavelength dispersion retardation, and a method for producing a thin phase difference plate having an inverse wavelength dispersion retardation.

### DESCRIPTION OF EMBODIMENTS

Hereinafter, the present invention will be described in detail with reference to embodiments and examples. However, the present invention is not limited to the following embodiments and examples, which may be optionally modified and implemented without departing from the scope of claims of the present invention and the scope of their equivalents.

In the following description, the resin having a positive intrinsic birefringence means a resin having a refractive index in a stretching direction which is larger than a refractive index in a direction orthogonal to the stretching direction. The resin having a negative intrinsic birefringence value means a resin having a refractive index in a stretching direction which is smaller than a refractive index in a direction orthogonal to the stretching direction. The intrinsic birefringence value may be calculated from a dielectric constant distribution.

In the following description, a retardation represents an in-plane retardation, unless otherwise specified. An in-plane retardation of a film is a value represented by (nx−ny)×t, unless otherwise specified. Here, nx represents a refractive index in a direction that is perpendicular to the thickness direction of the film (an in-plane direction) and provides a maximum refractive index. ny represents the refractive index in an in-plane direction of the film, which is perpendicular to the direction of nx. t represents the thickness of the film.

In the following description, a slow axis of a film represents an in-plane slow axis, unless otherwise specified.

In the following description, when the direction of an element is “parallel” and “perpendicular”, it may contain an error within the range that does not impair the effects of the present invention, for example, within the range of ±50, preferably ±30, and more preferably ±10, unless otherwise specified.

In the following description, the “phase difference plate”, “wave plate”, and “polarizing plate” are each used as a term which encompasses a flexible film and sheet such as a resin film, unless otherwise specified.

In the following description, “(meth)acrylic acid” is used as a term which encompasses both “acrylic acid” and “methacrylic acid”, unless otherwise specified.

In the following description, unless otherwise specified, the film having a long-length shape refers to a film having a length that is 5 or more times its width, preferably a length that is not 10 or more times its width, and specifically a length to a degree that allows the film to be wound up into a roll shape to be stored or transported. The upper limit of the ratio of the length relative to the width of a film may be, but not particularly limited to, equal to or less than 100,000 times.

[1. Outline of Phase Difference Plate]

The phase difference plate according to the present invention is a phase difference plate having a multi-layer structure which includes a first layer and a second layer. The first layer is formed from a resin having a positive intrinsic birefringence value, and has birefringence. Furthermore, the second layer is formed from a resin having a negative intrinsic birefringence value, and has birefringence. As the phase difference plate according to the present invention includes a combination of the first layer and the second layer, the phase difference plate has an inverse wavelength dispersion retardation. Such a phase difference plate according to the present invention is usually a thin film.

[2. First Layer]

The first layer is a layer which is formed from the resin having a positive intrinsic birefringence value. The type of the resin having a positive intrinsic birefringence value is not limited. However, in the phase difference plate according to the present invention, a crystallizable resin is preferably used as at least one, preferably both, of the resin having a positive intrinsic birefringence value contained in the first layer and the resin having a negative intrinsic birefringence value contained in the second layer, from the viewpoint of achieving both the thickness reduction of the phase difference plate and the expression of a desired retardation. Therefore, a crystallizable resin is preferable as the resin having a positive intrinsic birefringence value.

As described herein, the crystallizable resin refers to a resin which contains a crystallizable polymer. The crystallizable polymer refers to a polymer which has a melting point [that is, a polymer of which a melting point can be recognized using a differential scanning calorimeter (DSC)]. The crystallization of the crystallizable polymer tends to cause large birefringence to be expressed. Consequently, the use of such a crystallizable polymer can provide a high retardation in a thin phase difference plate.

Examples of a preferable crystallizable polymer which may be contained in the resin having a positive intrinsic birefringence value may include a crystallizable cyclic olefin polymer. The cyclic olefin polymer refers to a polymer which has an alicyclic structure in its molecule and is obtainable by a polymerization reaction with cyclic olefin as a monomer, or a hydrogenated product thereof.

Examples of the alicyclic structure that the cyclic olefin polymer has may include a cycloalkane structure and a cycloalkene structure. Among these, a cycloalkane structure is preferable, because the phase difference plate having excellent characteristics such as thermal stability is easily obtained. The number of carbon atoms contained in one alicyclic structure is preferably 4 or more, and more preferably 5 or more, and is preferably 30 or less, more preferably 20 or less, and particularly preferably 15 or less. When the number of carbon atoms contained in one alicyclic structure falls within the aforementioned range, mechanical strength, heat resistance, and molding properties are balanced at high levels.

The ratio of a structural unit having the alicyclic structure relative to all structural units in the cyclic olefin polymer is preferably 30% by weight or more, more preferably 50% by weight or more, and particularly preferably 70% by weight or more. When the ratio of the structural unit having the alicyclic structure in the cyclic olefin polymer is at such a high level, heat resistance can be enhanced.

The remainder other than the structural unit having the alicyclic structure of the cyclic olefin polymer is not particularly limited, and may be appropriately selected depending on an intended use.

Examples of the cyclic olefin polymer may include the following polymers (α) to (δ). Among these, the polymer (β) is preferable as the crystallizable cyclic olefin polymer, because the phase difference plate having particularly excellent heat resistance can be easily obtained.

Polymer (α): a ring-opened polymer of a cyclic olefin monomer, which has crystallizability.

Polymer (β): a hydrogenated product of the polymer (α), which has crystallizability.

Polymer (γ): an addition polymer of a cyclic olefin monomer, which has crystallizability.

Polymer (δ): a hydrogenated product of the polymer (γ) or the like, which has crystallizability.

Specifically, the cyclic olefin polymer is more preferably a ring-opened polymer of dicyclopentadiene which has crystallizability, and a hydrogenated product of the ring-opened polymer of dicyclopentadiene which has crystallizability, and particularly preferably a hydrogenated product of the ring-opened polymer of dicyclopentadiene which has crystallizability. As described herein, the ring-opened polymer of dicyclopentadiene refers to a polymer in which the ratio of the dicyclopentadiene-derived structural unit relative to all structural units is usually 50% by weight or more, preferably 70% by weight or more, more preferably 90% by weight or more, and further preferably 100% by weight.

Hereinafter, the method for producing the polymer (α) and the polymer (β) will be described.

The cyclic olefin monomer which may be used for producing the polymer (α) and the polymer (β) is a compound which has a cyclic structure formed of carbon atoms and includes a carbon-carbon double bond in the ring. Examples of the cyclic olefin monomer may include a norbornene-based monomer. When the polymer (α) is a copolymer, monocyclic olefin may also be used as the cyclic olefin monomer.

The norbornene-based monomer is a monomer which contains a norbornene ring. Examples of the norbornene-based monomer may include a bicyclic monomer, such as bicyclo[2.2.1]hept-2-ene (common name: norbornene), and 5-ethylidene-bicyclo[2.2.1]hept-2-ene (common name: ethylidene norbornene) and derivatives thereof (for example, a monomer which has a substituent on the ring); a tricyclic monomer, such as tricyclo[4.3.0.1^{2,5}]dec-3,7-diene (common name: dicyclopentadiene) and derivatives thereof; and a tetracyclic monomer, such as 7,8-benzotricyclo[4.3.0.1^{2,5}]dec-3-ene (common name: methanotetrahydrofluorene: also referred to as 1,4-methano-1,4,4a,9a-tetrahydrofluorene) and derivatives thereof, tetracyclo[4.4.0.1^{2,5}.1^{7,10}]dodeca-3-ene (common name: tetracyclododecene), and 8-ethylidenetetracyclo[4.4.0.1^{2,5}.1^{7,10}]-3-dodecene and derivatives thereof.

Examples of the substituent in the aforementioned monomer may include: an alkyl group, such as a methyl group and an ethyl group; an alkyenyl group, such as a vinyl group; an alkylidene group, such as propane-2-ylidene; an aryl group, such as a phenyl group; a hydroxy group; an acid anhydride group; a carboxyl group; and an alkoxycarbonyl group, such as a methoxycarbonyl group. As the aforementioned substituent, one type thereof may be solely used, and two or more types thereof may also be used in combination at any ratio.

Examples of the monocyclic olefin may include cyclic monoolefins, such as cyclobutene, cyclopentene, methylcyclopentene, cyclohexene, methylcyclohexene, cycloheptene, and cyclooctene; and cyclic diolefins, such as cyclohexadiene, methyl cyclohexadiene, cyclooctadiene, methyl cyclooctadiene, and phenyl cyclooctadiene.

As the cyclic olefin monomer, one type thereof may be solely used, and two or more types thereof may also be used in combination at any ratio. When two or more types of cyclic olefin monomers are used, the polymer (α) may be a block copolymer or a random copolymer.

Some cyclic olefin monomer may include endo- and exo-stereoisomers. As the cyclic olefin monomer, any one of the endo isomer and the exo isomer may be used. One of the endo isomer and the exo isomer may solely be used. Alternatively, an isomer mixture which contains the end isomer and the exo isomer at any ratio may also be used. Among these, it is preferable to use one of the stereoisomers at a higher ratio, because the crystallizability of the cyclic olefin polymer is enhanced so that the phase difference plate having more excellent birefringence and heat resistance can be easily obtained. For example, the ratio of the endo isomer or the exo isomer is preferably 80% or more, more preferably 90% or more, and further preferably 95% or more. It is preferable to use the endo isomer at a higher ratio because it can be easily synthesized.

For synthesizing the polymer (α), a ring-opening polymerization catalyst is usually used. As the ring-opening polymerization catalyst, one type thereof may be solely used, and two or more types thereof may also be used in combination at any ratio.

Such a ring-opening polymerization catalyst for synthesizing the polymer (α) is preferably capable of causing the cyclic olefin monomer to be ring-opening polymerized to generate a ring-opened polymer having syndiotactic stereoregularity. Examples of a preferable ring-opening polymerization catalyst may include a ring-opening polymerization catalyst which contains a metal compound represented by the following formula (1).

M(NR¹)X₄₋ₐ(OR²)ₐ·L_{b} (1)

(in the formula (1),

M is a metal atom selected from the group consisting of transition metal atoms of group 6 in the periodic table,

R¹ is a phenyl group optionally having a substituent at one or more of the 3-position, 4-position and 5-position, or a group represented by —CH₂R³ (R³ is a group selected from the group consisting of a hydrogen atom, an alkyl group optionally having a substituent, and an aryl group optionally having a substituent),

R² is a group selected from the group consisting of an alkyl group optionally having a substituent and an aryl group optionally having a substituent,

X is a group selected from the group consisting of a halogen atom, an alkyl group optionally having a substituent, an aryl group optionally having a substituent, and an alkylsilyl group,

L is an electron-donating neutral ligand,

a is a number of 0 or 1, and

b is an integer of 0 to 2).

In the formula (1), M is a metal atom selected from the group consisting of transition metal atoms of group 6 in the periodic table. This M is preferably chromium, molybdenum or tungsten, more preferably molybdenum or tungsten, and particularly preferably tungsten.

In the formula (1), R¹ is a phenyl group optionally having a substituent at one or more of the 3-position, 4-position and 5-position, or a group represented by —CH₂R³.

The number of carbon atoms of the phenyl group optionally having a substituent at one or more of the 3-position, 4-position and 5-position of R¹ is preferably 6 to 20, and more preferably 6 to 15. Examples of the substituent may include: an alkyl group, such as a methyl group and an ethyl group; a halogen atom, such as a fluorine atom, a chlorine atom, and a bromine atom; and an alkoxy group, such as a methoxy group, an ethoxy group, and an isopropoxy group. As the substituent, one type thereof may be solely used, and two or more types thereof may also be used in combination at any ratio. Furthermore, in R¹, the substituents present at two or more of the 3-position, 4-position and 5-position may be bonded to each other to form a cyclic structure.

Examples of the phenyl group optionally having a substituent at one or more of the 3-position, 4-position and 5-position may include: an unsubstituted phenyl group; a monosubstituted phenyl group, such as a 4-methylphenyl group, a 4-chlorophenyl group, a 3-methoxyphenyl group, a 4-cyclohexylphenyl group, and a 4-methoxyphenyl group; a disubstituted phenyl group, such as a 3,5-dimethylphenyl group, a 3,5-dichlorophenyl group, a 3,4-dimethylphenyl group, and a 3,5-dimethoxyphenyl group; a trisubstituted phenyl group, such as a 3,4,5-trimethylphenyl group, and a 3,4,5-trichlorophenyl group; and a 2-naphtyl group optionally having a substituent, such as a 2-naphtyl group, a 3-methyl-2-naphtyl group, and a 4-methyl-2-naphtyl group.

In the group represented by —CH₂R³ of R¹, R³ is a group selected from the group consisting of a hydrogen atom, an alkyl group optionally having a substituent, and an aryl group optionally having a substituent.

The number of carbon atoms of the alkyl group optionally having a substituent of R³ is preferably 1 to 20, and more preferably 1 to 10. This alkyl group may be linear or branched. Furthermore, examples of the substituent may include: a phenyl group optionally having a substituent, such as a phenyl group and a 4-methylphenyl group; and an alkoxyl group, such as a methoxy group and an ethoxy group. As the substituent, one type thereof may be solely used, and two or more types thereof may also be used in combination at any ratio.

Examples of the alkyl group optionally having a substituent of R³ may include a methyl group, an ethyl group, a propyl group, an isopropyl group, a butyl group, an isobutyl group, a t-butyl group, a pentyl group, a neopentyl group, a benzyl group, and a neophyl group.

The number of carbon atoms of the aryl group optionally having a substituent of R³ is preferably 6 to 20, and more preferably 6 to 15. Furthermore, examples of the substituent may include: an alkyl group, such as a methyl group and an ethyl group; a halogen atom, such as a fluorine atom, a chlorine atom, and a bromine atom; and an alkoxy group, such as a methoxy group, an ethoxy group, and an isopropoxy group. As the substituent, one type thereof may be solely used, and two or more types thereof may also be used in combination at any ratio.

Examples of the aryl group optionally having a substituent of R³ may include a phenyl group, a 1-naphtyl group, a 2-naphtyl group, a 4-methylphenyl group, and a 2,6-dimethylphenyl group.

Among these, as the group represented by R³, an alkyl group having 1 to 20 carbon atoms is preferable.

In the formula (1), R² is a group selected from the group consisting of an alkyl group optionally having a substituent and an aryl group optionally having a substituent. The alkyl group optionally having a substituent and the aryl group optionally having a substituent of R² may be any of those selected from the ranges enumerated as the alkyl group optionally having a substituent and the aryl group optionally having a substituent of R³, respectively.

In the formula (1), X is a group selected from the group consisting of a halogen atom, an alkyl group optionally having a substituent, an aryl group optionally having a substituent, and an alkylsilyl group.

Examples of the halogen atom of X may include a chlorine atom, a bromine atom, and an iodine atom.

The alkyl group optionally having a substituent and the aryl group optionally having a substituent of X may be any of those selected from the ranges enumerated as the alkyl group optionally having a substituent and the aryl group optionally having a substituent of R³, respectively.

Examples of the alkylsilyl group of X may include a trimethylsilyl group, a triethylsilyl group, and a t-butyldimethylsilyl group.

When the metal compound represented by the formula (1) has 2 or more X's in one molecule, those X's may be the same as or different from each other. Furthermore, the 2 or more X's may be bonded to each other to form a cyclic structure.

In the formula (1), L is an electron-donating neutral ligand.

Examples of the electron-donating neutral ligand of L may include an electron-donating compound which contains an atom of group 14 or 15 in the periodic table. Specific examples thereof may include: phosphines, such as trimethylphosphine, triisopropylphosphine, tricyclohexylphosphine, and triphenylphosphine; ethers, such as diethyl ether, dibutyl ether, 1,2-dimethoxyethane, and tetrahydrofuran; and amines, such as trimethylamine, triethylamine, pyridine, and lutidine. Among these, ethers are preferable. When the metal compound represented by the formula (1) has 2 or more L's in one molecule, those L's may be the same as or different from each other.

The metal compound represented by the formula (1) is preferably a tungsten compound having a phenyl imido group. That is, a compound of the formula (1) in which M is a tungsten atom, and R¹ is a phenyl group is preferable. Furthermore, among such compounds, a tetrachlorotungsten phenylimide (tetrahydrofuran) complex is more preferable.

The method for producing the metal compound represented by the formula (1) is not particularly limited. For example, the metal compound represented by the formula (1) may be produced by, as described in Japanese Patent Application Laid-Open No. Hei. 5-345817 A, mixing: an oxyhalide of the transition metal of group 6; phenyl isocyanates optionally having a substituent at one of 3-position, 4-position, and 5-position, or monosubstituted methyl isocyanates; an electron-donating neutral ligand (L); and as necessary, alcohols, metal alkoxide, and metal aryloxide.

In the aforementioned production method, the metal compound represented by the formula (1) is usually obtained in the state of being contained in a reaction solution. After the metal compound has been produced, the reaction solution as it is may be used as the catalyst solution for a ring-opening polymerization reaction. Alternatively, the metal compound having been isolated from the reaction solution and purified by a purification treatment such as crystallization may also be used in the ring-opening polymerization reaction.

As the ring-opening polymerization catalyst, the metal compound represented by the formula (1) may be solely used. Alternatively, the metal compound represented by the formula (1) may also be used in combination with another component. For example, polymerization activity can be enhanced by using a combination of the metal compound represented by the formula (1) and an organometallic reducing agent.

Examples of the organometallic reducing agent may include an organometallic compound of group 1, group 2, group 12, group 13, or group 14 in the periodic table, which has a hydrocarbon group with 1 to 20 carbon atoms. Examples of such an organometallic compound may include: organic lithium, such as methyl lithium, n-butyl lithium, and phenyl lithium; organic magnesium, such as butyl ethyl magnesium, butyl octyl magnesium, dihexyl magnesium, ethyl magnesium chloride, n-butyl magnesium chloride, and allyl magnesium bromide; organic zinc, such as dimethyl zinc, diethyl zinc, and diphenyl zinc; organic aluminum, such as trimethyl aluminum, triethyl aluminum, triisobutyl aluminum, diethyl aluminum chloride, ethyl aluminum sesquichloride, ethyl aluminum dichloride, diethyl aluminum ethoxide, diisobutyl aluminum isobutoxide, ethyl aluminum diethoxide, and isobutyl aluminum diisobutoxide; and organic tin, such as tetramethyl tin, tetra(n-butyl) tin, and tetraphenyl tin. Among these, organic aluminum or organic tin is preferable. As the organometallic reducing agent, one type thereof may be solely used, and two or more types thereof may also be used in combination at any ratio.

The ring-opening polymerization reaction is usually performed in an organic solvent. As the organic solvent, those which is capable of effecting dissolution or dispersion of a ring-opened polymer and a hydrogenated product thereof under a specific condition, and which does not inhibit the ring-opening polymerization reaction and the hydrogenation reaction may be used. Examples of such an organic solvent may include: an aliphatic hydrocarbon solvent, such as pentane, hexane, and heptane; an alicyclic hydrocarbon solvent, such as cyclopentane, cyclohexane, methylcyclohexane, dimethylcyclohexane, trimethylcyclohexane, ethylcyclohexane, diethylcyclohexane, decahydronaphthalene, bicycloheptane, tricyclodecane, hexahydroindene, and cyclooctane; an aromatic hydrocarbon solvent, such as benzene, toluene, and xylene; a halogen-based aliphatic hydrocarbon solvent, such as dichloromethane, chloroform, and 1,2-dichloroehane; a halogen-based aromatic hydrocarbon solvent, such as chlorobenzene and dichlorobenzene; a nitrogen-containing hydrocarbon solvent, such as nitromethane, nitrobenzene, and acetonitrile; an ether solvent, such as diethyl ether and tetrahydrofuran; and a mixed solvent thereof. Among these, as the organic solvent, an aromatic hydrocarbon solvent, an aliphatic hydrocarbon solvent, an alicyclic hydrocarbon solvent, and an ether solvent are preferable. As the organic solvent, one type thereof may be solely used, and two or more types thereof may also be used in combination at any ratio.

The ring-opening polymerization reaction may be initiated by, for example, mixing the cyclic olefin monomer, the metal compound represented by the formula (1), and as necessary, the organometallic reducing agent. The mixing order of these components is not particularly limited. For example, a solution containing the metal compound represented by the formula (1) and the organometallic reducing agent may be mixed with a solution containing the cyclic olefin monomer. Alternatively, a solution containing the cyclic olefin monomer and the metal compound represented by the formula (1) may be mixed with a solution containing the organometallic reducing agent. Furthermore, a solution containing the metal compound represented by the formula (1) may be mixed with a solution containing the cyclic olefin monomer and the organometallic reducing agent. When each component is mixed, the entire quantity of the component may be mixed at once, and may also be divided for a plurality of mixing steps. Mixing may also be continuously performed over a relatively long period of time (for example, one minute or more).

The concentration of the cyclic olefin monomer in the reaction solution when the ring-opening polymerization reaction is initiated is preferably 1% by weight or more, more preferably 2% by weight or more, and particularly preferably 3% by weight or more, and is preferably 50% by weight or less, more preferably 45% by weight or less, and particularly preferably 40% by weight or less. When the concentration of the cyclic olefin monomer is equal to or more than the lower limit value of the aforementioned range, productivity can be increased. When the concentration is equal to or less than the upper limit value, the viscosity of the reaction solution after the ring-opening polymerization reaction can be decreased. Accordingly, a subsequent hydrogenation reaction can be easily performed.

The amount of the metal compound represented by the formula (1) used in the ring-opening polymerization reaction is desirably set such that the molar ratio of “metal compound: cyclic olefin monomer” falls within a specific range. Specifically, the molar ratio is preferably 1:100 to 1:2,000,000, more preferably 1:500 to 1,000,000, and particularly preferably 1:1,000 to 1:500,000. When the amount of the metal compound is equal to or more than the lower limit value of the aforementioned range, sufficient polymerization activity can be obtained. When the amount is equal to or less than the upper limit value, the metal compound can be easily removed after the reaction.

The amount of the organometallic reducing agent, relative to 1 mol of the metal compound represented by the formula (1), is preferably 0.1 mol or more, more preferably 0.2 mol or more, and particularly preferably 0.5 mol or more, and is preferably 100 mol or less, more preferably 50 mol or less, and particularly preferably 20 mol or less. When the amount of the organometallic reducing agent is equal to or more than the lower limit value of the aforementioned range, polymerization activity can be sufficiently increased. When the amount is equal to or less than the upper limit value, occurrence of a side reaction can be suppressed.

The polymerization reaction system of the polymer (α) may contain an activity adjuster. The use of the activity adjuster can stabilize the ring-opening polymerization catalyst, and also can achieve adjustment of the reaction rate of the ring-opening polymerization reaction and the molecular weight distribution of the polymer.

As the activity adjuster, an organic compound having a functional group may be used. Examples of such an activity adjuster may include an oxygen-containing compound, a nitrogen-containing compound, and a phosphorous-containing organic compound.

Examples of the oxygen-containing compound may include: ethers, such as diethyl ether, diisopropyl ether, dibutyl ether, anisole, furan, and tetrahydrofuran; ketones, such as acetone, benzophenone, and cyclohexanone; and esters, such as ethyl acetate.

Examples of the nitrogen-containing compound may include: nitriles, such as acetonitrile and benzonitrile; amines, such as triethylamine, triisopropylamine, quinuclidine, and N,N-diethylaniline; and pyridines, such as pyridine, 2,4-lutidine, 2,6-lutidine, and 2-t-butylpyridine.

Examples of the phosphorous-containing compound may include: phosphines, such as triphenylphosphine, tricyclohexylphosphine, triphenyl phosphate, and trimethyl phosphate; and phosphine oxides, such as triphenylphosphine oxide.

As the activity adjuster, one type thereof may be solely used, and two or more types thereof may also be used in combination at any ratio.

The amount of the activity adjuster in the polymerization reaction system of the polymer (α), relative to 100 mol % of the metal compound represented by the formula (1), is preferably 0.01 mol % to 100 mol %.

The polymerization reaction system of the polymer (α) may contain a molecular weight adjuster for adjusting the molecular weight of the polymer (α). Examples of the molecular weight adjuster may include: α-olefins, such as 1-butene, 1-pentene, 1-hexene, and 1-octene; an aromatic vinyl compound, such as styrene and vinyl toluene; an oxygen-containing vinyl compound, such as ethyl vinyl ether, isobutyl vinyl ether, allyl glycidyl ether, allyl acetate, allyl alcohol, and glycidyl methacrylate; a halogen-containing vinyl compound, such as allyl chloride; a nitrogen-containing vinyl compound, such as acrylamide; non-conjugated diene, such as 1,4-pentadiene, 1,4-hexadiene, 1,5-hexadiene, 1,6-heptadiene, 2-methyl-1,4-pentadiene, and 2,5-dimethyl-1,5-hexadiene; and conjugated diene, such as 1,3-butadiene, 2-methyl-1,3-butadiene, 2,3-dimethyl-1,3-butadiene, 1,3-pentadiene, and 1,3-hexadiene.

As the molecular weight adjuster, one type thereof may be solely used, and two or more types thereof may also be used in combination at any ratio.

The amount of the molecular weight adjuster in the polymerization reaction system for polymerizing the polymer (α) may be appropriately determined depending on an intended molecular weight. The specific amount of the molecular weight adjuster, relative to the cyclic olefin monomer, is preferably in the range of 0.1 mol. to 50 mol %.

The polymerization temperature is preferably −78° C. or higher, and more preferably −30° C. or higher, and is preferably +200° C. or lower, and more preferably +180° C. or lower.

The polymerization time may be dependent on the reaction scale. The specific polymerization time is preferably in the range of 1 minute to 1000 hours.

By the aforementioned production method, the polymer (α) is obtained. By hydrogenating this polymer (α), the polymer (β) may be produced.

The hydrogenation of the polymer (α) may be performed by, for example, supplying hydrogen into a reaction system containing the polymer (α), in the presence of a hydrogenation catalyst, according to a method known in the art. When the reaction condition is appropriately set in this hydrogenation reaction, the tacticity of the hydrogenated product is not usually changed by the hydrogenation reaction.

As the hydrogenation catalyst, a homogeneous catalyst and a heterogeneous catalyst which are known as a hydrogenation catalyst of an olefin compound may be used. Examples of the homogeneous catalyst may include: a catalyst which is composed of a combination of a transition metal compound and an alkali metal compound, such as cobalt acetate/triethyl aluminum, nickel acetylacetonate/triisobutyl aluminum, titanocene dichloride/n-butyl lithium, zirconocene dichloride/sec-butyl lithium, and tetrabutoxy titanate/dimethyl magnesium; and a noble metal complex catalyst such as dichlorobis(triphenylphosphine) palladium, chlorohydridecarbonyltris(triphenylphosphine) ruthenium, chlorohydridecarbonylbis(tricyclohexylphosphine) ruthenium, bis(tricyclohexylphosphine)benzylidine ruthenium (IV) dichloride, and chlorotris(triphenylphosphine) rhodium.

Examples of the heterogeneous catalyst may include: a metal catalyst, such as nickel, palladium, platinum, rhodium, and ruthenium; and a solid catalyst obtained by allowing the aforementioned metal to be carried by a carrier, such as carbon, silica, diatomaceous earth, alumina, and titanium oxide, such as nickel/silica, nickel/diatomaceous earth, nickel/alumina, palladium/carbon, palladium/silica, palladium/diatomaceous earth, and palladium/alumina.

As the hydrogenation catalyst, one type thereof may be solely used, and two or more types thereof may also be used in combination at any ratio.

The hydrogenation reaction is usually performed in an inactive organic solvent. Examples of the inactive organic solvent may include: an aromatic hydrocarbon solvent, such as benzene and toluene; an aliphatic hydrocarbon solvent, such as pentane and hexane; an alicyclic hydrocarbon solvent, such as cyclohexane and decahydronaphthalene; and an ether solvent, such as tetrahydrofuran and ethylene glycol dimethyl ether. As the inactive organic solvent, one type thereof may be solely used, and two or more types thereof may also be used in combination at any ratio. The inactive organic solvent may be the same as or different from the organic solvent used in the ring-opening polymerization reaction. Furthermore, the hydrogenation reaction may be performed by mixing the hydrogenation catalyst with the reaction solution of the ring-opening polymerization reaction.

The reaction conditions for the hydrogenation reaction usually vary depending on used hydrogenation catalysts.

The reaction temperature for the hydrogenation reaction is preferably −20° C. or higher, more preferably −10° C. or higher, and particularly preferably 0° C. or higher, and is preferably +250° C. or lower, more preferably +220° C. or lower, and particularly preferably +200° C. or lower. When the reaction temperature is equal to or higher than the lower limit value of the aforementioned range, the reaction rate can be increased. When the reaction temperature is equal to or lower than the upper limit value, occurrence of a side reaction can be suppressed.

The hydrogen pressure is preferably 0.01 MPa or more, more preferably 0.05 MPa or more, and particularly preferably 0.1 MPa or more, and is preferably 20 MPa or less, more preferably 15 MPa or less, and particularly preferably 10 MPa or less. When the hydrogen pressure is equal to or more than the lower limit value of the aforementioned range, the reaction rate can be increased. When the hydrogen pressure is equal to or less than the upper limit value, a special apparatus such as a high pressure-resistant reaction vessel is not required, and facility costs can thereby be reduced.

The reaction time of the hydrogenation reaction is not particularly limited as long as a desired hydrogenation ratio is achieved, and preferably 0.1 hour to 10 hours.

After the hydrogenation reaction, the polymer (β), which is the hydrogenated product of the polymer (α), is usually recovered according to a method known in the art.

The hydrogenation rate (the ratio of a hydrogenated main chain double bond) in the hydrogenation reaction is preferably 98% or more, and more preferably 99% or more. Higher hydrogenation ratio can result in better heat resistance of the cyclic olefin polymer.

Here, the hydrogenation ratio of the polymer may be measured by a ¹H-NMR measurement at 145° C., with ortho-dichlorobenzene-d⁴ as a solvent.

Subsequently, the method for producing the polymer (γ) and the polymer (δ) will be described. The cyclic olefin monomer to be used for producing the polymers (γ) and (δ) may be any of those selected from the range enumerated as the cyclic olefin monomers to be used for producing the polymers (α) and (β). As the cyclic olefin monomer, one type thereof may be solely used, and two or more types thereof may also be used in combination at any ratio.

In the production of the polymer (γ), an optional monomer which is copolymerizable with the cyclic olefin monomer may be used as a monomer, in combination with the cyclic olefin monomer. Examples of the optional monomer may include: α-olefin with 2 to 20 carbon atoms, such as ethylene, propylene, 1-butene, 1-pentene, and 1-hexene; an aromatic ring vinyl compound, such as styrene and α-methylstyrene; and non-conjugated diene, such as 1,4-hexadiene, 4-methyl-1,4-hexadiene, 5-methyl-1,4-hexadiene, and 1,7-octadiene. Among these, α-olefin is preferable, and ethylene is more preferable. As the optional monomer, one type thereof may be solely used, and two or more types thereof may also be used in combination at any ratio.

The amount ratio between the cyclic olefin monomer and the optional monomer in terms of a weight ratio (cyclic olefin monomer: optional monomer) is preferably 30:70 to 99:1, more preferably 50:50 to 97:3, and particularly preferably 70:30 to 95:5.

When two or more types of the cyclic olefin monomers are used, and when the cyclic olefin monomers and the optional monomer are used in combination, the polymer (γ) may be a block copolymer or a random copolymer.

For synthesizing the polymer (γ), an addition polymerization catalyst is usually used. Examples of such an addition polymerization catalyst may include a vanadium-based catalyst formed of a vanadium compound and an organoaluminum compound, a titanium-based catalyst formed of a titanium compound and an organoaluminum compound, and a zirconium-based catalyst formed of a zirconium complex and aluminoxane. As the addition polymerization catalyst, one type thereof may be solely used, and two or more types thereof may also be used in combination at any ratio.

The amount of the addition polymerization catalyst relative to 1 mol of the monomer is preferably 0.000001 mol or more, and more preferably 0.00001 mol or more, and is preferably 0.1 mol or less, and more preferably 0.01 mol or less.

The addition polymerization of the cyclic olefin monomer is usually performed in an organic solvent. The organic solvent may be any of those selected from the range enumerated as the organic solvents which may be used for the ring-opening polymerization of the cyclic olefin monomer. As the organic solvent, one type thereof may be solely used, and two or more types thereof may also be used in combination at any ratio.

The polymerization temperature in the polymerization for producing the polymer (γ) is preferably −50° C. or higher, more preferably −30° C. or higher, and particularly preferably −20° C. or higher, and is preferably 250° C. or lower, more preferably 200° C. or lower, and particularly preferably 150° C. or lower. The polymerization time is preferably 30 minutes or more, and more preferably 1 hour or more, and is preferably 20 hours or less, and more preferably 10 hours or less.

By the aforementioned production method, the polymer (γ) is obtained. By hydrogenating this polymer (γ), the polymer (δ) may be produced.

The hydrogenation of the polymer (γ) may be performed by the same method as the method previously described as the method for hydrogenating the polymer (α).

The aforementioned crystallizable cyclic olefin polymer preferably has a syndiotactic structure, and more preferably has a high degree of the syndiotactic stereoregularity. This can enhance the crystallizability of the cyclic olefin polymer. Accordingly, the birefringence of the first layer can be effectively increased. The degree of the syndiotactic stereoregularity of the cyclic olefin polymer may be measured by the ratio of a racemo diad in the cyclic olefin polymer. The specific ratio of a racemo diad in the cyclic olefin polymer is preferably 51% or more, more preferably 60% or more, and particularly preferably 70% or more.

The ratio of a racemo diad in the cyclic olefin polymer may be measured by ¹³C-NMR spectrum analysis. Specifically, the ratio may be measured by the following method.

¹³C-NMR measurement of the cyclic olefin polymer is performed by applying an inverse-gated decoupling method at 150° C., with ortho-dichlorobenzene-d⁴ as a solvent. From the result of this ¹³C-NMR measurement, the ratio of a racemo diad in the cyclic olefin polymer may be calculated on the basis of the ratio in strength between the signal at 43.35 ppm derived from a meso diad and the signal at 43.43 ppm derived from a racemo diad, with the peak at 127.5 ppm of ortho-dichlorobenzene-d⁴ as a reference shift.

The melting point of the crystallizable polymer contained in the resin having a positive intrinsic birefringence value is preferably 200° C. or higher, and more preferably 230° C. or higher, and is preferably 290° C. or lower. The use of the crystallizable polymer having such a melting point can provide a phase difference plate having a still better balance between molding properties and heat resistance.

As the polymer contained in the resin having a positive intrinsic birefringence value, one type thereof may be solely used, and two or more types thereof may also be used in combination at any ratio.

The weight-average molecular weight (Mw) of the polymer contained in the resin having a positive intrinsic birefringence value is preferably 1,000 or more, and more preferably 2,000 or more, and is preferably 1,000,000 or less, and more preferably 500,000 or less. The polymer having such a weight-average molecular weight has an excellent balance between molding processability and heat resistance.

The molecular weight distribution (Mw/Mn) of the polymer contained in the resin having a positive intrinsic birefringence value is preferably 1.0 or more, and more preferably 1.5 or more, and is preferably 4.0 or less, and more preferably 3.5 or less. Here, Mn represents a number-average molecular weight. The polymer having such a molecular weight distribution is excellent in molding processability.

The weight-average molecular weight (Mw) and the molecular weight distribution (Mw/Mn) of the polymer may be measured in terms of polystyrene by gel permeation chromatography (GPC) with tetrahydrofuran as a development solvent.

The glass transition temperature Tg of the polymer contained in the resin having a positive intrinsic birefringence value is not particularly limited, and is usually in the range of 85° C. or higher and 170° C. or lower.

The ratio of the polymer in the resin having a positive intrinsic birefringence value is preferably 50% by weight or more, more preferably 70% by weight or more, and particularly preferably 90% by weight or more. In particular, it is preferable that the ratio of the crystallizable polymer falls within the aforementioned range. This can particularly reduce the thickness of the phase difference plate.

The resin having a positive intrinsic birefringence value may contain an optional component, in addition to the aforementioned polymer. Examples of the optional component may include: an antioxidant, such as a phenol-based antioxidant, a phosphorus-based antioxidant, and a sulfur-based antioxidant; a light stabilizer, such as a hindered amine-based light stabilizer; waxes, such as petroleum-based waxes, Fischer-Tropsch waxes, and polyalkylene waxes; a nucleating agent, such as a sorbitol-based compound, a metal salt of an organic phosphoric acid, a metal salt of an organic carboxylic acid, kaolin, and talc; a fluorescent brightener, such as a diaminostilbene derivative, a coumarin derivative, an azole-based derivative (for example, a benzooxazol derivative, a benzotriazole derivative, a benzoimidazole derivative, and a benzothiazole derivative), a carbazole derivative, a pyridine derivative, a naphthalic acid derivative, and an imidazolon derivative; an ultraviolet ray absorber, such as a benzophenone-based ultraviolet ray absorber, a salicylic acid-based ultraviolet ray absorber, and a benzotriazole-based ultraviolet ray absorber; an inorganic filler, such as talc, silica, calcium carbonate, and glass fiber; a colorant; a frame retardant; a flame retardant aid; an antistatic agent; a plasticizer; a near-infrared ray absorber; a lubricant; and a filler. As the optional component, one type thereof may be solely used, and two or more types thereof may also be used in combination at any ratio.

The first layer is a layer having optical anisotropy, and has birefringence. As described herein, the layer having birefringence refers to a layer which usually has a birefringence of 0.0001 or more. Since the first layer has birefringence, a retardation is expressed in the first layer. As a result of the difference between this retardation of the first layer and the retardation of the second layer, an inverse wavelength dispersion retardation as the entire phase difference plate can be obtained. The specific range of the birefringence of the first layer may be set depending on the value of a retardation required for the phase difference plate. For example, the birefringence of the first layer is preferably 0.01 or more, more preferably 0.015 or more, and particularly preferably 0.02 or more. The upper limit is not particularly limited, and is preferably 0.1 or less.

Usually, the slow axis of the first layer is set such that it is orthogonal to the slow axis of the second layer when viewed from the thickness direction. Thereby the difference between the retardation of the first layer and the retardation of the second layer can stably provide an inverse wavelength dispersion retardation as the entire phase difference plate.

When the phase difference plate according to the present invention has a long-length shape, it is preferable that the angle formed between the slow axis of the first layer and the longitudinal direction of the phase difference plate falls within a specific range.

Specifically, the angle is preferably 40° or more, more preferably 42° or more, and particularly preferably 44° or more, and is preferably 50° or less, more preferably 48° or less, and particularly preferably 46° or less. When the angle formed between the slow axis of the first layer and the longitudinal direction of the phase difference plate falls within the aforementioned range, a circularly polarizing plate can be easily produced using the phase difference plate according to the present invention.

A circularly polarizing plate generally includes a phase difference plate and a polarizer. Such a circularly polarizing plate is produced by, for example, bonding a polarizer having a long-length shape and a phase difference plate having a long-length shape such that they become parallel to each other in their longitudinal directions. The polarized light transmission axis of the polarizer is usually parallel to or perpendicular to the longitudinal direction of the polarizer. Furthermore, the slow axis of the entire phase difference plate is usually generated in a direction that is parallel to or perpendicular to the slow axis of the first layer. Therefore, when the angle formed between the slow axis of the first layer and the longitudinal direction of the phase difference plate falls within the aforementioned range, bonding by which the polarized light transmission axis of the polarizer and the slow axis of the phase difference plate form an angle of 45°±5° can be easily performed. Thus, a circularly polarizing plate can be easily produced.

It is preferable that the first layer is thin within a range that allows the entire phase difference plate to express an inverse wavelength dispersion retardation. The specific thickness of the first layer is preferably 1 μm or more although the lower limit is not particularly limited, and is preferably 40 μm or less, more preferably 30 μm or less, and particularly preferably 20 μm or less. When the thickness of the first layer is equal to or more than the lower limit value of the aforementioned range, a desired retardation can be expressed in the phase difference plate. When the thickness is equal to or less than the upper limit value, thickness of the phase difference plate can be effectively reduced.

[3. Second Layer]

The second layer is a layer which is formed from the resin having a negative intrinsic birefringence value. The type of the resin having a negative intrinsic birefringence value is not limited. However, as to the phase difference plate according to the present invention, a crystallizable resin is preferable as the resin having a negative intrinsic birefringence value, from the viewpoint of achieving both the thickness reduction of the phase difference plate and the expression of a desired retardation. The use of the crystallizable resin as the resin having a negative intrinsic birefringence value can cause large birefringence to be expressed when a crystallizable polymer contained in the crystallizable resin is crystallized. Accordingly, a high retardation can be obtained in a thin phase difference plate.

Examples of a preferable crystallizable polymer which may be contained in the resin having a negative intrinsic birefringence value may include a crystallizable styrene-based polymer. The styrene-based polymer is a polymer which contains a structural unit formed by polymerizing a styrene-based compound (hereinafter, appropriately referred to as a “styrenic unit”), and a hydrogenated product thereof. Examples of the styrene-based compound may include styrene and a styrene derivative. Examples of the styrene derivative may include styrene substituted with a substituent at its benzene ring or its α-position.

Examples of the styrene-based compound may include: styrene; an alkylstyrene, such as methylstyrene and 2,4-dimethylstyrene; a styrene halide, such as chlorostyrene; a halogen-substituted alkylstyrene, such as chloromethylstyrene; and an alkoxystyrene, such as methoxystyrene. Among these, styrene which does not have a substituent is preferable as the styrene-based compound. As the styrene-based compound, one type thereof may be solely used, and two or more types thereof may also be used in combination at any ratio.

Examples of the styrene-based polymer may include polystyrene, poly(alkylstyrene), poly(styrene halide), poly(alkylstyrene halide), poly(alkoxystyrene), poly(vinyl benzoic acid ester), and hydrogenated polymers thereof, as well as copolymers thereof.

Examples of poly(alkylstyrene) may include poly(methylstyrene), poly(ethylstyrene), poly(isopropylstyrene), poly(t-butylstyrene), poly(phenylstyrene), poly(vinylnaphthalene), and poly(vinylstyrene).

Examples of poly(styrene halide) may include poly(chlorostyrene), poly(bromostyrene), and poly(fluorostyrene).

Examples of poly(alkylstyrene halide) may include poly(chloromethylstyrene).

Examples of poly(alkoxystyrene) may include poly(methoxystyrene) and poly(ethoxystyrene).

Among these, examples of a particularly preferable styrene-based polymer may include polystyrene, poly(p-methylstyrene), poly(m-methylstyrene), poly(p-t-butylstyrene), poly(p-chlorostyrene), poly(m-chlorostyrene), poly(p-fluorostyrene), hydrogenated polystyrene, and copolymers which contain these structural units.

The styrene-based polymer may be a homopolymer having only one type of the structural unit, or may be a copolymer having two or more types of the structural units. When the styrene-based polymer is a copolymer, it may be a copolymer which contains two or more types of styrenic units, or may be a copolymer which contains a styrenic unit and a structural unit other than the styrenic unit. However, when the styrene-based polymer is a copolymer which contains a styrenic unit and a structural unit other than the styrenic unit, the content of a structural unit other than the styrenic unit in the styrene-based polymer is preferably small. Specifically, the content of the styrenic unit in the styrene-based polymer is preferably 804 by weight or more, more preferably 83% by weight or more, and particularly preferably 85% by weight or more. Usually, when the amount of the styrenic unit falls within such a range, a desired retardation can be expressed in the second layer.

The styrene-based polymer having crystallizability preferably has a syndiotactic structure. As described herein, the styrene-based polymer having a syndiotactic structure refers to a styrene-based polymer having a syndiotactic structure as a stereochemical structure. The syndiotactic structure of a styrene-based polymer means a stereostructure in which phenyl groups as side chains are alternately located in the opposite direction with respect to a main chain formed by a carbon-carbon bond in the Fischer projection formula.

The tacticity (stereoregularity) of the styrene-based polymer may be quantified by a nuclear magnetic resonance method with isotopic carbon (¹³C-NMR). The tacticity measured by the ¹³C-NMR method may be indicated by the ratios of a plurality of constitutional units which are continuously present. In general, a case wherein the number of continuous constitutional units is two is a diad, three is a triad, and five is a pentad. In this case, the styrene-based polymer having a syndiotactic structure refers to a styrene-based polymer having a syndiotacticity of usually 75% or more, and preferably 85% or more in terms of a racemic diad, or a styrene-based polymer having a syndiotacticity of usually 30% or more, and preferably 50% or more in terms of a racemic pentad. In either case, the ideal upper limit of the syndiotacticity may be 100%.

The styrene-based polymer having a syndiotactic structure may be produced by polymerizing a styrene-based compound in an inactive hydrocarbon solvent or in the absence of a solvent, using as a catalyst a titanium compound and a condensation product of water and trialkyl aluminum (see Japanese Patent Application Laid-Open No. Sho. 62-187708 A). Poly(alkylstyrene halide) may be produced by, for example, the method described in Japanese Patent Application Laid-Open No. Hei. 1-146912 A. Furthermore, hydrogenated polymers thereof may be produced by, for example, the method described in Japanese Patent Application Laid-Open No. Hei. 1-178505 A.

The melting point of the crystallizable polymer contained in the resin having a negative intrinsic birefringence value is preferably 200° C. or higher, and more preferably 230° C. or higher, and is preferably 290° C. or lower. The use of the crystallizable polymer having such a melting point can provide the phase difference plate having a still better balance between molding properties and heat resistance.

As the polymer contained in the resin having a negative intrinsic birefringence value, one type thereof may be solely used, and two or more types thereof may also be used in combination at any ratio.

The weight-average molecular weight (Mw) of the polymer contained in the resin having a negative intrinsic birefringence value is preferably 130,000 or more, more preferably 140,000 or more, and particularly preferably 150,000 or more, and is preferably 300,000 or less, more preferably 270,000 or less, and particularly preferably 250,000 or less. Since the polymer having such a weight-average molecular weight has a high glass transition temperature, the heat resistance of the phase difference plate can be effectively enhanced.

The glass transition temperature of the polymer contained in the resin having a negative intrinsic birefringence value is preferably 85° C. or higher, more preferably 90° C. or higher, and particularly preferably 95° C. or higher. When the glass transition temperature falls within such a range, the heat resistance of the phase difference plate can be effectively improved. From the viewpoint of stably facilitating the production of the phase difference plate, the glass transition temperature of the polymer contained in the resin having a negative intrinsic birefringence value is preferably 160° C. or lower, more preferably 155° C. or lower, and particularly preferably 150° C. or lower.

The ratio of the polymer in the resin having a negative intrinsic birefringence value is preferably 50% by weight or more, more preferably 70% by weight or more, and particularly preferably 904 by weight or more. In particular, it is preferable that the ratio of the crystallizable polymer falls within the aforementioned range. This can particularly reduce the thickness of the phase difference plate.

The resin having a negative intrinsic birefringence value may contain an optional component, in addition to the aforementioned polymer. Examples of the optional component may include the same examples as those of the optional component which may be contained in the resin having a positive intrinsic birefringence value. As the optional component, one type thereof may be solely used, and two or more types thereof may also be used in combination at any ratio.

The second layer is a layer having optical anisotropy, and has birefringence. The specific range of the birefringence of the second layer may be set depending on the value of the retardation required for the phase difference plate. For example, the birefringence of the second layer is preferably 0.02 or more, more preferably 0.04 or more, and particularly preferably 0.05 or more. The upper limit is not particularly limited, and is preferably 0.1 or less.

Usually, the slow axis of the second layer is set such that it is orthogonal to the slow axis of the first layer when viewed from the thickness direction. When the phase difference plate according to the present invention has a long-length shape, it is preferable that the angle formed between the slow axis of the second layer and the longitudinal direction of the phase difference plate falls within a specific range. Specifically, the angle is preferably −50° or more, more preferably −48° or more, and particularly preferably −46° or more, and is preferably −40° or less, more preferably −42° or less, and particularly preferably −44° or less. When the angle formed between the slow axis of the second layer and the longitudinal direction of the phase difference plate falls within the aforementioned range, a circularly polarizing plate can be easily produced using the phase difference plate according to the present invention.

It is preferable that the second layer is thin within a range that allows the entire phase difference plate to express an inverse wavelength dispersion retardation. The specific thickness of the second layer is preferably 1 μm or more although the lower limit is not particularly limited, and is preferably 10 m or less, more preferably 7 μm or less, and particularly preferably 5 μm or less. When the thickness of the second layer is equal to or more than the lower limit value of the aforementioned range, a desired retardation can be expressed in the phase difference plate. When the thickness is equal to or less than the upper limit value, thickness of the phase difference plate can be effectively reduced.

[4. Third Layer]

The phase difference plate according to the present invention preferably has, between the first layer and the second layer, a third layer which is capable of bonding the first layer and the second layer. This can suppress peeling between the first layer and the second layer, thereby enhancing the mechanical strength of the phase difference plate according to the present invention.

As the material of the third layer, any adhesive may be used. Examples of the adhesive may include an acrylic adhesive, a urethane adhesive, a polyester adhesive, a polyvinyl alcohol adhesive, a polyolefin adhesive, a modified polyolefin adhesive, a polyvinyl alkyl ether adhesive, a vinyl chloride-vinyl acetate adhesive, an ethylene adhesive, and an acrylic acid ester adhesive. As the adhesive, one type thereof may be solely used, and two or more types thereof may also be used in combination at any ratio.

Among the aforementioned adhesives, an adhesive which contains an elastomer is preferable. The use of the elastomer-containing adhesive causes the third layer to become a soft layer which contains an elastomer, thereby effectively enhancing the mechanical strength of the phase difference plate. Examples of the elastomer may include: an ethylene-based elastomer, such as a styrene-butadiene-styrene copolymer (SBS copolymer) and a hydrogenated product thereof (SEBS copolymer), a styrene-ethylene/propylene-styrene copolymer hydrogenated product (SEPS copolymer), an ethylene-vinyl acetate copolymer, and an ethylene-styrene copolymer; and an acrylic acid ester-based elastomer, such as an ethylene-methyl methacrylate copolymer, an ethylene-methyl acrylate copolymer, an ethylene-ethyl methacrylate copolymer, and an ethylene-ethyl acrylate copolymer. Among these, an aromatic vinyl-conjugated diene-based elastomer such as a styrene-butadiene-styrene copolymer (SBS copolymer) and a hydrogenated product thereof (SEBS copolymer), and a styrene-ethylene/propylene-styrene copolymer hydrogenated product (SEPS copolymer) is preferable. As the elastomer, one type thereof may be solely used, and two or more types thereof may also be used in combination at any ratio.

Usually, the third layer is a layer having optical isotropy, and does not have birefringence. As described herein, the layer which does not have birefringence usually refers to a layer having a birefringence of less than 0.0001. Since the third layer does not have birefringence, a large retardation is not expressed in the third layer. Consequently, the effect by the third layer on the retardation of the entire phase difference plate can be ignored. Therefore, the retardation of the phase difference plate can be easily adjusted.

The thickness of the third layer is preferably 0.1 μm or more, and more preferably 1 μm or more, and is preferably 30 μm or less, and more preferably 10 μm or less. When the thickness of the third layer is equal to or more than the lower limit value of the aforementioned range, the third layer can have an enhanced adhesive capability. When the thickness is equal to or less than the upper limit value, the thickness of the phase difference plate can be effectively reduced.

[5. Optional Layer]

The phase difference plate according to the present invention may further include an optional layer, in addition to the aforementioned first layer, second layer, and third layer. Examples of the optional layer may include an antistatic layer, a hardcoat layer, and an antifouling layer.

[6. Characteristics of Phase Difference Plate]

A retardation Re(450) [unit: nm] at a wavelength of 450 nm of the phase difference plate according to the present invention and a retardation Re(550) [unit: nm] at a wavelength of 550 nm of the phase difference plate according to the present invention satisfy the following formula (I).

Re(450)/Re(550)<0.92 (I)

More particularly, Re(450)/Re(550) is usually less than 0.92, more preferably 0.91 or less, and particularly preferably 0.90 or less. The formula (I) indicates that the retardation of the phase difference plate according to the present invention has excellent inverse wavelength dispersion. By having such an excellent inverse wavelength dispersion retardation, the phase difference plate according to the present invention can uniformly express its function in a wide range of wavelength bands. The lower limit value of Re(450)/Re(550) is not particularly limited, and is preferably 0.60 or more, more preferably 0.70 or more, and particularly preferably 0.75 or more.

The retardation Re(550) [unit: nm] at a wavelength of 550 nm of the phase difference plate according to the present invention and a thickness d [unit: nm] of the phase difference plate according to the present invention satisfy the following formula (II).

Re(550)/d>0.0035 (II)

More particularly, Re(550)/d is usually more than 0.0035, more preferably 0.0040 or more, and particularly preferably 0.0045 or more. The formula (II) indicates that the phase difference plate according to the present invention has a thin thickness for the retardation of the phase difference plate. It has been difficult for the prior-art phase difference plate having an inverse wavelength dispersion retardation to have sufficiently thin thickness to satisfy the formula (II). However, the phase difference plate according to the present invention can have thin thickness to a degree that has been difficult to achieve with the prior-art phase difference plate. The upper limit value of Re(550)/d is not particularly limited, and is preferably 0.01 or less.

The specific retardation of the phase difference plate according to the present invention may be set depending on an intended use of the phase difference plate. For example, the retardation Re(550) at a wavelength of 550 nm of the phase difference plate which can function as a 1/4 wave plate is preferably 80 nm or more, more preferably 100 nm or more, and particularly preferably 120 nm or more, and is preferably 180 nm or less, more preferably 160 nm or less, and particularly preferably 150 nm or less.

The direction of the slow axis of the phase difference plate according to the present invention may be any direction. However, when the phase difference plate according to the present invention has a long-length shape, it is preferable that the angle formed between the slow axis of the phase difference plate and the longitudinal direction of the phase difference plate falls within a specific range. Specifically, the angle is preferably 40° or more, more preferably 42° or more, and particularly preferably 44° or more, and is preferably 50° or less, more preferably 48° or less, and particularly preferably 46° or less. When the angle formed between the slow axis of the phase difference plate and the longitudinal direction of the phase difference plate falls within the aforementioned range, a circularly polarizing plate can be easily produced using the phase difference plate according to the present invention.

It is preferable that the phase difference plate according to the present invention is excellent in transparency. Specifically, the total light transmittance of the phase difference plate according to the present invention is preferably 70% or more, more preferably 80% or more, and particularly preferably 904 or more. The total light transmittance of the phase difference plate may be measured using an ultraviolet-visible spectrometer, in the wavelength range of 400 nm to 700 nm.

It is preferable that the phase difference plate according to the present invention has low haze.

Specifically, the haze of the phase difference plate according to the present invention is preferably 10% or less, more preferably 5% or less, and particularly preferably 3% or less. The haze of the phase difference plate can be measured using a haze meter, with a thin film sample having a shape of a 50 mm×50 mm square obtained by cutting out the phase difference plate at a random position.

The thickness d of the phase difference plate according to the present invention can be appropriately set depending on a retardation required of the phase difference plate. However, the phase difference plate is preferably as thin as possible. For example, the thickness of the phase difference plate which can function as a 1/4 wave plate is preferably 60 μm or less, more preferably 40 μm or less, and particularly preferably 30 μm or less. The thickness of a prior-art 1/4 wave plate having an inverse wavelength dispersion retardation was usually about 90 μm, and it was difficult to further reduce the thickness. However, the phase difference plate according to the present invention can be thinner than a prior-art plate while having an inverse wavelength dispersion retardation which allows for functioning as a 1/4 wave plate. The lower limit of the thickness of the phase difference plate is not particularly limited, and is usually 5 μm or more.

[7. Method for Producing Phase Difference Plate]

As the method for producing the phase difference plate according to the present invention, any method by which the aforementioned phase difference plate can be obtained may be employed. Especially, from the viewpoint of efficient production, the phase difference plate according to the present invention is preferably produced by a production method which includes:

(a) a first step of co-extruding a resin having a positive intrinsic birefringence value and a resin having a negative intrinsic birefringence value to obtain a pre-stretch layered body which includes a first layer formed from the resin having a positive intrinsic birefringence value and a second layer formed from the resin having a negative intrinsic birefringence value;

(b) a second step of stretching the pre-stretch layered body after the first step to obtain a stretched body; and

(c) a third step of promoting crystallization of at least one of the resin having a positive intrinsic birefringence value and the resin having a negative intrinsic birefringence value of the stretched body after the second step to obtain a phase difference plate.

In the first step, the resin having a positive intrinsic birefringence value and the resin having a negative intrinsic birefringence value are co-extruded. When a phase difference plate which includes an optional layer such as a third layer other than the first and second layers is produced, a material of the optional layer may be co-extruded in combination with the resin having a positive intrinsic birefringence value and the resin having a negative intrinsic birefringence value. During the co-extrusion, all of the resins are extruded in a melted state into layers. Examples of the extrusion method of the resins may include a coextrusion T die method, a coextrusion inflation method, and a coextrusion lamination method. Among these, a coextrusion T die method is preferable. The coextrusion T die method includes a feed block system and a multi-manifold system, and a multi-manifold system is particularly preferable in terms of smaller variations in thickness.

In the first step, the melting temperature of the resins to be extruded is preferably (Tg+80)° C. or higher, and more preferably (Tg+100)° C. or higher, and is preferably (Tg+180)° C. or lower, and more preferably (Tg+170)° C. or lower. As described herein, “Tg” represents the highest temperature among the glass transition temperatures of the polymers contained in the resin having a positive intrinsic birefringence value or the resin having a negative intrinsic birefringence value. When the melting temperature of the resins to be extruded is equal to or more than the lower limit value of the aforementioned range, the fluidity of the resins can be sufficiently enhanced, to thereby achieve favorable molding properties. When the melting temperature is equal to or lower than the upper limit value, the deterioration of the resins can be suppressed.

In the first step, the temperature of the resins in an extruder is preferably Tg to (Tg+100° C.) at a resin charging inlet, and preferably (Tg+50° C.) to (Tg+170° C.) at an outlet of an extruder. The die temperature is preferably (Tg+50° C.) to (Tg+170° C.).

In the co-extrusion method, the melted resin of a film shape extruded through a die lip are usually brought into intimate contact with a cooling roll for cooling, so that the resins are cured. At this time, examples of the method for bringing melted resins into intimate contact with a cooling roll may include an air knife system, a vacuum box system, and an electrostatic adhesion system.

The number of cooling rolls is not particularly limited, and is usually two or more. Examples of the manner of disposing the cooling rolls may include straight line-type, Z-type, and L-type. At this time, the method of guiding the melted resins extruded from a die lip to the cooling rolls is not particularly limited.

By co-extruding the resins as previously described, a pre-stretch layered body which includes the first layer formed from the resin having a positive intrinsic birefringence value and the second layer formed from the resin having a negative intrinsic birefringence value can be obtained. This pre-stretch layered body is usually a film having a long-length shape.

In the second step, the pre-stretch layered body is stretched. As the stretching, a uniaxial stretching treatment in which a stretching treatment is performed only in one direction is usually performed. The stretching to be performed may be any one of a longitudinal stretching treatment in which stretching is performed in the longitudinal direction of the pre-stretch layered body, a lateral stretching treatment in which stretching is performed in the width direction of the pre-stretch layered body, and a diagonal stretching treatment in which stretching is performed in a diagonal direction that is neither parallel to nor perpendicular to the longitudinal direction of the pre-stretch layered body. Among these, a diagonal stretching treatment is preferable. Examples of the system of the stretching treatment may include a roll system, a float system, and a tenter system.

The stretching temperature and the stretching ratio may be set to any values as long as the phase difference plate having a desired retardation can be obtained. The specific range of the stretching temperature is preferably (Tg−30)° C. or higher, and more preferably (Tg−10)° C. or higher, and is preferably (Tg+60)° C. or lower, and more preferably (Tg+50)° C. or lower. The stretching ratio is preferably 1.1 times or more, more preferably 1.2 times or more, and particularly preferably 1.5 times or more, and is preferably 30 times or less, more preferably 10 times or less, and particularly preferably 5 times or less.

By performing stretching as previously described, a stretched body which includes the first layer formed from the resin having a positive intrinsic birefringence value and the second layer formed from the resin having a negative intrinsic birefringence value can be obtained. In this stretched body, polymer molecules contained in the resin having a positive intrinsic birefringence value and polymer molecules contained in the resin having a negative intrinsic birefringence value are oriented in the stretching direction. Therefore, a slow axis parallel to the stretching direction is expressed in the first layer formed from the resin having a positive intrinsic birefringence value, and a slow axis perpendicular to the oriented direction is expressed in the second layer formed from the resin having a negative intrinsic birefringence value. Accordingly, the entire stretched body has a retardation corresponding to a difference between the retardation of the first layer and the retardation of the second layer. The slow axis of the entire stretched body is usually expressed in a direction parallel to the slow axis of the first layer.

The retardation of the entire stretched body exhibits inverse wavelength dispersion. The mechanism in which the retardation of the stretched body exhibits inverse wavelength dispersion is usually as follows. However, the present invention is not limited to the following mechanism.

In general, the retardation of the first layer and the retardation of the second layer each exhibit normal wavelength dispersion. The normal wavelength dispersion retardation refers to a retardation which exhibits a smaller value for a transmitted light having a longer wavelength. Here, a stretched body is assumed such that, among the first layer and the second layer, the layer having a large retardation has smaller normal wavelength dispersion than the layer having a small retardation. In such a stretched body, the retardation in a long wavelength of the layer having a large retardation is not drastically lowered compared to the retardation in a short wavelength. In contrast to this, the retardation in a long wavelength of the layer having a small retardation is drastically lowered compared to the retardation in a short wavelength. Therefore, in the stretched body assumed as previously described, a retardation difference between both the layers is small in a short wavelength, and large in a long wavelength. Thus, an inverse wavelength dispersion retardation can be expressed.

Since the retardation of the stretched body exhibits inverse wavelength dispersion, a retardation Re(450) at a wavelength of 450 nm of the stretched body is smaller than a retardation Re(550) at a wavelength of 550 nm of the stretched body. At this time, the retardations Re(450) and Re(550) of the stretched body preferably satisfy the foregoing formula (I). Accordingly, the phase difference plate according to the present invention can be stably produced.

In the third step, crystallization of at least one of the resin having a positive intrinsic birefringence value and the resin having a negative intrinsic birefringence value each contained in the stretched body is promoted to obtain the phase difference plate according to the present invention. As described herein, promoting the crystallization of a resin refers to promoting the crystallization of a crystallizable polymer contained in the resin. In the third step, it is preferable that both of the resin having a positive intrinsic birefringence value and the resin having a negative intrinsic birefringence value each contained in the stretched body is promoted.

The promotion of crystallization may be performed by heating the stretched body. The heating temperature is preferably in a specific temperature range of not lower than the glass transition temperature of the crystallizable polymer and not higher than the melting point of the crystallizable polymer. Accordingly, the crystallization of the polymer can effectively proceed. Furthermore, within the specific temperature range, the temperature is preferably set such that the speed of the crystallization increases. For example, when the hydrogenated product of the ring-opened polymer of dicyclopentadiene is used as the crystallizable cyclic olefin polymer, the heating temperature is preferably 110° C. or higher, and more preferably 120° C. or higher, and is preferably 240° C. or lower, and more preferably 220° C. or lower.

Since a heating apparatus is not required to be in contact with the stretched body, a heating apparatus capable of raising the atmospheric temperature of the stretched body is preferable as a heating apparatus for heating the stretched body. Specific examples of a suitable heating apparatus may include an oven and a heating furnace.

Furthermore, in the third step, it is preferable that the stretched body is heated in a state in which the stretched body is strained. As described herein, “a state in which the stretched body is strained” refers to a state in which tension is applied to the stretched body. However, this state in which the stretched body is strained does not include a state in which the stretched body is substantially stretched. “Substantially stretched” refers to a state wherein the stretching ratio in any direction of the stretched body becomes usually 1.1 times or more. Accordingly, deformation of the stretched body due to thermal shrinkage can be suppressed.

Straining of the stretched body is usually achieved by applying tension to the stretched body while retaining the stretched body with an appropriate holder. The holder of the stretched body to be used at this time is not limited. For example, examples of a holder for a rectangular stretched body may include grippers such as clips which are disposed in a frame at specific intervals and can grip sides of the stretched body. Examples of a holder for a long-length stretched body which holds two sides at the ends in the width direction may include grippers which is provided to a tenter stretching machine and can grip sides of the stretched body. Furthermore, for example, tension such as conveyance tension may be applied to the stretched body by a plurality of rolls disposed in the upstream and downstream of a region where a long-length stretched body is heated.

In the third step, the treatment time during which the stretched body is to be maintained at a specific temperature range is preferably 5 seconds or more, and more preferably 10 seconds or more, and is preferably 1 hour or less. By this treatment, crystallization of the crystallizable polymer can sufficiently proceed.

Heating causes crystallization of the polymer contained in the resin having a positive intrinsic birefringence value and the polymer contained in the resin having a negative intrinsic birefringence value to proceed while their orientation states are maintained. Usually, as the crystallization proceeds, the birefringence of the polymer becomes larger. Therefore, the crystallization causes the birefringence of the first layer and the birefringence of the second layer to become larger, and thereby the retardation of the first layer and the retardation of the second layer also become larger. Consequently, the crystallization can increase a difference in retardation between the first layer and the second layer, and the phase difference plate according to the present invention which is thin and has a desired inverse wavelength dispersion retardation can thereby be obtained.

The aforementioned method for producing the phase difference plate may further include an optional step, in addition to the first step, the second step, and the third step. For example, the aforementioned production method may include a step of performing an optional surface treatment to the phase difference plate.

[8. Use of Phase Difference Plate]

There is no particular limitation to the use of the phase difference plate according to the present invention. The phase difference plate may be used as any type of optical film. For example, the phase difference plate according to the present invention is used as: an optical compensation film for display devices such as liquid crystal display devices and organic EL display devices; and a polarizing plate protection film. In particular, it is preferable that the phase difference plate according to the present invention is used in a circularly polarizing plate in combination with a linear polarizer.

The aforementioned circularly polarizing plate includes a linear polarizer and the phase difference plate according to the present invention. As the linear polarizer, a publicly known liner polarizer which is used in devices such as liquid crystal display devices may be used. Examples of the linear polarizer may include a product obtained by allowing iodine or a dichroic dye to be adsorbed to a polyvinyl alcohol film, and thereafter performing uniaxial stretching in a boric acid bath; and a product obtained by allowing iodine or a dichroic dye to be adsorbed to a polyvinyl alcohol film, performing stretching, and modifying portion of a polyvinyl alcohol unit in a molecular chain into a polyvinylene unit. Other examples of the linear polarizer may include a polarizer having the function of separating polarized light into reflected light and transmitted light, such as a grid polarizer, a multi-layer polarizer, and a cholesteric liquid crystal polarizer. Among these, a polarizer which contains polyvinyl alcohol is preferable.

When natural light is allowed to enter a linear polarizer, only one polarized light transmits through the linear polarizer. The polarization degree of the linear polarizer is preferably 98% or more, and more preferably 99% or more. The average thickness of the linear polarizer is preferably 5 μm to 80 μm.

The phase difference plate to be provided to the circularly polarizing plate preferably has an appropriate retardation such that it can function as a 1/4 wave plate. The angle formed between the slow axis of the phase difference plate and the polarized light transmission axis of the linear polarizer is preferably 450 or angles near 450, and specifically preferably 400 to 500, when viewed from the thickness direction.

One of the uses of such a circularly polarizing plate may include a use as an antireflective film for display devices such as organic EL display devices. When the circularly polarizing plate is provided to the surface of a display device such that the surface on the linear polarizer side faces the viewing side, light which enters from the outside of the device can be prevented from exiting the device after reflection in the device. As a result, glare on the display surface of the display device can be suppressed. Specifically, only part of the linearly polarized light of the light having entered from the outside of the device passes through the liner polarizer, and subsequently passes through the phase difference plate, to thereby become circularly polarized light. The circularly polarized light is reflected on a constituent element (such as a reflective electrode) which permits the light in the device to be reflected thereon, and thereafter passes through the phase difference plate again. In this manner, the light becomes linearly polarized light having its polarizing axis in a direction orthogonal to the polarizing axis of the incident linearly polarized light. Accordingly, the linearly polarized light does not pass through the linear polarizer. Thus, the function of antireflection is achieved.

### EXAMPLES

Hereinafter, the present invention will be specifically described by illustrating Examples. However, the present invention is not limited to following Examples, and may be practiced with any modification without departing from the scope of claims of the present invention and the scope of their equivalents. In the following description, “%” and “parts” indicating quantity are on the basis of weight, unless otherwise specified. Furthermore, the operation described hereinafter was performed in the atmosphere at a normal temperature and normal pressure, unless otherwise specified.

[Evaluation Method]

[Method for Measuring Ratio of Racemo Diad in Polymer]

The ¹³C-NMR measurement of a polymer was performed adopting an inverse-gated decoupling method at 150° C., with ortho-dichlorobenzene-d⁴ as the solvent. From the result of this ¹³C-NMR measurement, the ratio of a racemo diad in the polymer was calculated, on the basis of the ratio in strength between the signal at 43.35 ppm derived from a meso diad and the signal at 43.43 ppm derived from a racemo diad, with the peak at 127.5 ppm of ortho-dichlorobenzene-d⁴ as a reference shift.

[Method for Measuring Retardation of Phase Difference Plate]

The retardation Re of the phase difference plate was measured by a parallel Nicol rotation method, using a phase difference measuring device (“KOBRA-WR” manufactured by Oji Scientific Instruments, Co. Ltd.). In the measurement, the retardations measured at an incident angle of 00 (in the normal line direction of the phase difference plate) and at wavelengths of 450 nm and 550 nm were measured as Re(450) and Re(550) respectively.

[Method for Measuring Retardations of Layers Contained in Phase Difference Plate]

The thickness of each layer was measured from a scanning electron microscope (SEM) photograph of the cross section of a phase difference plate. Subsequently, the surface of the phase difference plate was etched from the second layer side, using a dry etching device (“RIE-10NE” manufactured by Samco, Inc.). Several types of samples which have been subjected to etching for varied times from 10 minutes to 60 minutes was obtained, and each of the samples was measured for retardation and thickness. From the values of the variations in retardation and thickness, the retardation of each layer was calculated.

[Method for Calculating Reflectivity Ratio of Circularly Polarizing Plate by Simulation]

Circularly polarizing plates produced in Examples and Comparative Examples were each modeled using “LCD Master” manufactured by Shintec, Inc. as a simulation software, and the reflectivity ratio was calculated.

In the model for simulation, there was modeled a structure in which a circularly polarizing plate is bonded on a planar reflecting surface of a mirror such that the circularly polarizing plate on the phase difference plate side is in contact with the mirror. Therefore, with this model, a structure in which the polarizing film, the phase difference plate, and the mirror are disposed in this order in the thickness direction was modeled.

Then, with the aforementioned model, the reflectivity ratio when the circularly polarizing plate is irradiated with light from a D65 light source was calculated in (i) the front direction and (ii) the tilt direction of the circularly polarizing plate. As described herein, in (i) the front direction, the reflectivity ratio at a polar angle of 0° and an azimuth angle of 0° was calculated. In (ii) the tilt direction, the reflectivity at a polar angle of 45° and at every 5° in the azimuth angle direction within the azimuth angle range of 0° to 360° was calculated, and an average for the calculated values was adopted as the reflectivity ratio in the tilt direction of the modeled circularly polarizing plate.

[Method for Visual Evaluation of Circularly Polarizing Plate]

A mirror having a planar reflecting surface was prepared. This mirror was placed such that its reflecting surface becomes horizontal and upward. A circularly polarizing plate was bonded on the reflecting surface of this mirror such that the polarizing film side becomes upward.

Thereafter, the circularly polarizing plate on the mirror was visually observed in a state of being exposed to sunlight on a sunny day. The observation was performed in both

(i) a front direction at a polar angle of 0° and an azimuth angle of 0° and

(ii) a tilt direction at a polar angle of 45° and an azimuth angle of 0° to 360°, of the circularly polarizing plate.

In the observation in (i) the front direction, it was evaluated whether the reflection of sunlight is hardly noticeable and the circularly polarizing plate looks black. In the observation in (ii) the tilt direction, it was evaluated whether the reflectivity ratio and the color tone do not change depending on azimuth angles.

These evaluations (i) and (ii) were judged into five stages A to E in the order of favorable evaluation.

### Production Example 1. Production of Hydrogenated Product of Ring-Opened Polymer of Dicyclopentadiene

A metal pressure-resistant reaction vessel was sufficiently dried. Thereafter, the atmosphere in the vessel was substituted with nitrogen. Into this metal pressure-resistant reaction vessel, 154.5 parts of cyclohexane, 42.8 parts (30 parts as the amount of dicyclopentadiene) of a 70% cyclohexane solution of dicyclopentadiene (endo-form content rate: 99% or more), and 1.9 parts of 1-hexene were added, and heated to 53° C.

Into a solution in which 0.014 parts of a tetrachlorotungsten phenylimide (tetrahydrofuran) complex was dissolved in 0.70 parts of toluene, 0.061 parts of a 19% diethyl aluminum ethoxide/n-hexane solution were added, and stirred for 10 minutes. Thus, a catalyst solution was prepared.

This catalyst solution was added in the pressure-resistant reaction vessel to initiate a ring-opening polymerization reaction. Thereafter, the reaction proceeded for 4 hours while 53° C. was maintained. Thus, a solution of a ring-opened polymer of dicyclopentadiene was obtained.

The number-average molecular weight (Mn) and the weight-average molecular weight (Mw) of the obtained ring-opened polymer of dicyclopentadiene were 8,750 and 28,100, respectively. The molecular weight distribution (Mw/Mn) calculated from these was 3.21.

Into 200 parts of a solution of the obtained ring-opened polymer of dicyclopentadiene, 0.037 parts of 1,2-ehanediol as a terminator were added. The mixture was heated to 60° C., and stirred for one hour to terminate the polymerization reaction. To the obtained product, 1 part of a hydrotalcite-like compound (“Kyoward (registered trademark) 2000” manufactured by Kyowa Chemical Industry Co., Ltd.) was added. The mixture was heated to 60° C., and stirred for one hour. Thereafter, 0.4 parts of a filtration auxiliary (“Radiolite (registered trademark) #1500” manufactured by Showa Chemical Industry Co., Ltd.) were added, and the adsorbent and the solution were separated by filtering, using a PP pleated cartridge filter (“TCP-HX” manufactured by Advantec Toyo Kaisha Ltd.).

To 200 parts (polymer amount: 30 parts) of the solution of the ring-opened polymer of dicyclopentadiene after the filtering, 100 parts of cyclohexane was added. To this mixture, 0.0043 parts of chlorohydridecarbonyltris(triphenylphosphine) ruthenium was added. Then, a hydrogenation reaction was performed at a hydrogen pressure of 6 MPa and a temperature of 180° C. for 4 hours. Accordingly, a reaction solution which contains a hydrogenated product of the ring-opened polymer of dicyclopentadiene was obtained. The hydrogenated product had been deposited, and this reaction solution had become a slurry solution.

The hydrogenated product contained in the aforementioned reaction solution was separated from the solution using a centrifuge, and dried under reduced pressure at 60° C. for 24 hours. Thus, 28.5 parts of the hydrogenated product of the ring-opened polymer of dicyclopentadiene was obtained as the cyclic olefin polymer having crystallizability. This hydrogenated product had a hydrogenation rate of 99% or more, a glass transition temperature of 95° C., and a racemo diad ratio of 89%.

### Example 1

(1-1. Production of Resin A)

To 100 parts of the hydrogenated product of the ring-opened polymer of dicyclopentadiene produced in Production Example 1, 1.1 parts of an antioxidant (tetrakis[methylene-3-(3′,5′-di-t-butyl-4′-hydroxyphenyl)propionate]methane; “Irganox (registered trademark) 1010” manufactured by BASF Japan Ltd.) was mixed, to thereby obtain a resin A.

The obtained resin A was charged into a biaxial extruder (“TEM-37B” manufactured by Toshiba Machine Co. Ltd.) which is provided with four die holes each having an inner diameter of 3 mm. By the biaxial extruder, the resin was molded into a strand-like molded body by hot melt extrusion molding. This molded body was shredded with a strand cutter to thereby obtain pellets of the resin A. The operation conditions of the aforementioned biaxial extruder are indicated below.
Barrel preset temperature: 270° C. to 280° C.
Die preset temperature: 250° C.
Screw revolutions: 145 rpm
Feeder revolutions: 50 rpm

(1-2. Production of Layered Body)

A film molding apparatus for 3-type 3-layer co-extruding which has three uniaxial extruders a, b, and c each including a double flight-type screw was prepared. As described herein, the film molding apparatus of 3-type 3-layer refers to a film molding apparatus which is capable of producing a film having a three-layer structure with three types of resins. The film molding apparatus used in the present Example was configured to be capable of producing a film which includes, in this order, a layer of the resin charged into the uniaxial extruder a, a layer of the resin charged into the uniaxial extruder b, and a layer of the resin charged into the uniaxial extruder c.

Pellets of the aforementioned resin A were charged into the uniaxial extruder a. An aromatic vinyl-conjugated diene-based elastomer (“Tuftec H1062” manufactured by Asahi Kasei Corp.) was charged into the uniaxial extruder b. Furthermore, pellets of a polystyrene resin (“Xarec 130ZC” manufactured by Idemitsu Kosan Co., Ltd., glass transition temperature: 100° C.) which contains polystyrene having a syndiotactic structure were charged into the uniaxial extruder c. Thereafter, the resins charged into the uniaxial extruders a, b, and c were each melted at an extrusion temperature of 260° C.

The resin A, the aromatic vinyl-conjugated diene-based elastomer, and the polystyrene resin, which had been melted, were supplied to a multi-manifold die through a leaf disc-shaped polymer filter having an opening of 10 μm, and concurrently extruded into a film shape from the multi-manifold die at 260° C. The extruded film-like melted resins were cast on a cooling roll which was adjusted to have a surface temperature of 100° C., and subsequently passed between two cooling rolls which were adjusted to have a surface temperature of 50° C. Thus, a pre-stretch film as the pre-stretch layered body was obtained (first step). The obtained pre-stretch film was a multilayer film with a thickness of 48.3 μm, which includes the layer of the resin A (34.6 μm)/the layer of the aromatic vinyl-conjugated diene-based elastomer (5.0 μm)/the layer of the polystyrene resin (8.7 μm) in this order.

(1-3. Stretching)

The pre-stretch film was subjected to free uniaxial stretching using a tension tester equipped with a constant temperature bath, to thereby produce a stretched film as the stretched body (second step). The stretching conditions at this time are as follows.
Stretching temperature: 100° C.
Stretching ratio: 3 times
Stretching speed: 3 times/minute

In the obtained stretched film, the retardation Re(450) at a wavelength of 450 nm and the retardation Re(550) at a wavelength of 550 nm satisfied “Re(450)/Re(550)<0.92”.

(1-4. Promotion of Crystallization)

The stretched film was cut out to be a size of a 50 mm square. Four sides of the square were held by a frame so that the stretched film was strained. While the stretched film was kept in a strained state in this manner, this stretched film was subjected to a heat treatment (third step). The heating conditions at this time were a treatment temperature of 180° C. and a treatment time of 2 minutes. This promoted the crystallization of the hydrogenated product of the ring-opened polymer of dicyclopentadiene contained in the resin A and the polystyrene contained in the polystyrene resin, of the stretched film. Thus, a phase difference plate having a thickness of 28 μm was obtained. The retardation of each layer and the retardation of the entirety of the obtained phase difference plate were measured by the aforementioned method.

(1-5. Production of Circularly Polarizing Plate)

A resin film made of polyvinyl alcohol having been dyed with iodine and having a long-length shape was prepared. This resin film was stretched in a longitudinal direction which forms an angle of 90° relative to the width direction of the resin film, to thereby obtain a polarizing film having a long-length shape. This polarizing film had its absorption axis in the longitudinal direction of the polarizing film, and its polarized light transmission axis in the width direction of the polarizing film.

An optical transparent adhesive sheet (“LUCIACS CS9621T” manufactured by Nitto Denko Corporation) was prepared as a layer of an adhesive. With this adhesive sheet, the polarizing film and the phase difference plate were bonded together such that the angle formed between the absorption axis of the polarizing film and the slow axis of the phase difference plate becomes 45°. Thus, a circularly polarizing plate was obtained.

The obtained circularly polarizing plate was evaluated by the aforementioned method.

### Example 2

In the step (1-2), the extrusion thickness of each resin when the resin was extruded to obtain a pre-stretch film was changed.

A phase difference plate and a circularly polarizing plate were produced and evaluated in the same manner as that in Example 1 except for the aforementioned matter.

### Comparative Example 1

In the step (1-2), a resin which contains a non-crystallizable cyclic olefin polymer (“ZNR 1215” manufactured by ZEON Corporation, glass transition temperature: 130° C.) was used instead of the resin A, a resin which contains a non-crystallizable styrene-maleic anhydride copolymer (“Dylark D332” manufactured by Nova Chemicals Inc., glass transition temperature: 135° C.) was used instead of the polystyrene resin which contains polystyrene having a syndiotactic structure, and the extrusion thickness of each resin when the resin was extruded to obtain a pre-stretch film was changed.

A phase difference plate and a circularly polarizing plate were produced and evaluated in the same manner as that in Example 1 except for the aforementioned matters.

### Comparative Example 2

In the step (1-2), a resin which contains a non-crystallizable cyclic olefin polymer (“ZNR 1215” manufactured by ZEON Corporation) was used instead of the resin A, and a resin which contains a non-crystallizable styrene-maleic anhydride copolymer (“Dylark D332” manufactured by Nova Chemicals Inc.) was used instead of the polystyrene resin which contains polystyrene having a syndiotactic structure.

A phase difference plate and a circularly polarizing plate were produced and evaluated in the same manner as that in Example 1 except for the aforementioned matters.

### Comparative Example 3

In the step (1-2), the extrusion thickness of each resin when the resin was extruded to obtain a pre-stretch film was changed.

A phase difference plate and a circularly polarizing plate were produced and evaluated in the same manner as that in Example 1 except for the aforementioned matter.

[Results]

The results of the aforementioned Examples and Comparative Examples are shown in the following table. In the following table, abbreviations mean as follows.

Layer of positive resin: a layer of a resin having a positive intrinsic birefringence value

Layer of negative resin: a layer of a resin having a negative intrinsic birefringence value

polyD: a resin which contains a crystallizable hydrogenated product of a ring-opened polymer of dicyclopentadiene

ZNR: a resin which contains a non-crystallizable cyclic olefin polymer

PSP: a polystyrene resin which contains crystallizable polystyrene having a syndiotactic structure

SMA: a resin which contains a non-crystallizable styrene-maleic anhydride copolymer

Reflectivity ratio (i): reflectivity ratio in the front direction of a circularly polarizing plate.

Reflectivity ratio (ii): reflectivity ratio in the tilt direction of a circularly polarizing plate.

TABLE 1
[Results of Examples and Comparative Examples]

| | | | | | Comp. | Comp. | Comp. |
|---|---|---|---|---|---|---|---|
| | | | Ex. 1 | Ex. 2 | Ex. 1 | Ex. 2 | Ex. 3 |
| Element | Layer of | Resin | polyD | polyD | ZNR | ZNR | polyD |
| | positive | Thickness | 20 | 18 | 68 | 20 | 14 |
| | resin | (μm) | | | | | |
| | | Re (550) | 420 | 378 | 420 | 124 | 294 |
| | | (nm) | | | | | |
| | Layer of | Resin | SPS | SPS | SMA | SMA | SPS |
| | negative | Thickness | 5 | 4.25 | 31 | 5 | 2.75 |
| | resin | (μm) | | | | | |
| | | Re (550) | 280 | 238 | 280 | 45 | 154 |
| | | (nm) | | | | | |
| Evaluation | Phase | Total | 28 | 25 | 102 | 28 | 20 |
| | difference | thickness | | | | | |
| | plate | (μm) | | | | | |
| | | Re (450) | 123 | 126 | 123 | 77 | 131 |
| | | (nm) | | | | | |
| | | Re (550) | 140 | 140 | 140 | 79 | 140 |
| | | (nm) | | | | | |
| | | Re (450)/ | 0.88 | 0.90 | 0.88 | 0.97 | 0.94 |
| | | Re (550) | | | | | |
| | Circularly | Reflectivity | 0.15 | 0.19 | 0.15 | 15.25 | 0.30 |
| | polarizing | ratio (i) | | | | | |
| | plate | Reflectivity | 1.52 | 1.56 | 1.51 | 14.95 | 1.64 |
| | | ratio (ii) | | | | | |
| | | Visual | A | A | A | C | B |
| | | observation | | | | | |

[Discussion]

In Comparative Example 1, a desired retardation was obtained, but the thickness was not decreased. In Comparative Example 2, the thickness was decreased, resulting in failure to obtain a desired retardation. Furthermore, in Comparative Example 3, a desired retardation was not obtained at a wavelength of 450 nm, resulting in poor inverse wavelength dispersion of the retardation of the phase difference plate, which led to poor antireflection performance of the circularly polarizing plate. On the other hand, in Examples 1 and 2, favorable results were obtained. As understood from these results, it was confirmed that according to the present invention, a phase difference plate which has an inverse wavelength dispersion retardation and is thin can be achieved, whereby a circularly polarizing plate having excellent antireflection properties can be obtained.

1. A phase difference plate comprising:
a first layer which is formed from a resin having a positive intrinsic birefringence value, and has birefringence; and
a second layer which is formed from a resin having a negative intrinsic birefringence value, and has birefringence, wherein
a retardation Re(450) at a wavelength of 450 nm of the phase difference plate, a retardation Re(550) at a wavelength of 550 nm of the phase difference plate, and a thickness d of the phase difference plate satisfy formula (I) and formula (II),
Re(450)/Re(550)<0.92 (I), and
Re(550)/d>0.0035 (II).

2. The phase difference plate according to claim 1, wherein at least one of the resin having a positive intrinsic birefringence value and the resin having a negative intrinsic birefringence value is a crystallizable resin.

3. The phase difference plate according to claim 2, wherein the resin having a positive intrinsic birefringence value contains a crystallizable cyclic olefin polymer.

4. The phase difference plate according to claim 3, wherein the crystallizable cyclic olefin polymer has a syndiotactic structure.

5. The phase difference plate according to according to claim 2, wherein the resin having a negative intrinsic birefringence value contains a crystallizable styrene-based polymer.

6. The phase difference plate according to claim 5, wherein the crystallizable styrene-based polymer has a syndiotactic structure.

7. The phase difference plate according to claim 1, wherein
the phase difference plate has a long-length shape,
an angle formed between a slow axis of the first layer and a longitudinal direction of the phase difference plate is 40° or more and 50° or less, and
an angle formed between a slow axis of the second layer and a longitudinal direction of the phase difference plate is −50° or more and −40° or less.

8. The phase difference plate according to claim 1, comprising, between the first layer and the second layer, a third layer which contains an elastomer.

9. The phase difference plate according to claim 8, wherein the elastomer is an aromatic vinyl-conjugated diene-based elastomer.

10. A method for producing a phase difference plate, the method comprising:
a first step of co-extruding a resin having a positive intrinsic birefringence value and a resin having a negative intrinsic birefringence value to obtain a pre-stretch layered body which includes a first layer formed from the resin having a positive intrinsic birefringence value and a second layer formed from the resin having a negative intrinsic birefringence value;
a second step of stretching the pre-stretch layered body after the first step to obtain a stretched body, wherein a retardation Re(450) at a wavelength of 450 nm of the stretched body and a retardation Re(550) at a wavelength of 550 nm of the stretched body satisfy formula (I); and
a third step of promoting crystallization of at least one of the resin having a positive intrinsic birefringence value and the resin having a negative intrinsic birefringence value of the stretched body after the second step to obtain a phase difference plate in which the retardation Re(550) at a wavelength of 550 nm and a thickness d satisfy formula (II),
Re(450)/Re(550)<0.92 (I), and
Re(550)/d>0.0035 (II).
